(19) United States
(12) Patent Application Publication
(10) Pub. No.: US 2010/0024613 A1
(43) Pub. Date: Feb. 4, 2010

(54) METHOD OF CUTTING THE PIPE AND APPARATUS PERFORMING THE SAME

(76) Inventor: In Sung Choi, Metropolitan (KR)

Correspondence Address: GREER, BURNS & CRAIN, 300 S WACKER DR, 25TH FLOOR, CHICAGO, IL, 60606, US

(21) Appl. No.: 12/294,191

(22) PCT Filed: Mar. 12, 2007
(86) PCT No.: PCT/KR07/01191

§ 371 Date: May 21, 2009

(30) Foreign Application Priority Data
Mar. 28, 2006 (KR) 10-2006-0027836

(51) Int. Cl. B23B 5/14; B23D 21/04

(52) U.S. Cl. 82/47; 82/70.1

(57) ABSTRACT

Disclosed are a method for cutting a pipe which allows precise straight cutting and beveling of a pipe, which can be used irrespective of the size of a pipe, and which can completely remove chips generated by cutting to reduce pollution of the pipe, and an apparatus for performing the same. The apparatus includes a housing; guide bodies separately positioned on the housing to be selectively moved toward or away from each other; guide rolls installed on the guide bodies so that a pipe to be cut can be placed thereon; a rotation device for manually or automatically rotating the guide rolls to rotate the pipe; and a cutting device installed on a side surface of the housing, and having a cutting handle which is pivoted around a hinge to cut a lower portion of the pipe and a cutter which is installed on a distal end of the cutting handle.

### TECHNICAL FIELD

The present invention relates to a cutting apparatus, and more particularly, to a method for cutting a pipe which makes possible precise and straight cutting and beveling of a pipe and can be used irrespective of the size of a pipe, and an apparatus for performing the same.

### BACKGROUND ART

As is generally known in the art, a pipe cutting apparatus, which is widely used in various industrial fields, is composed of a die for supporting or fastening a pipe, a cutter for cutting the pipe, and a motor for rotating the cutter. Pipe cutting apparatuses are divided into an abrasive cutting apparatus and a sawing apparatus depending upon the kind of cutter.

In the abrasive cutting apparatus, in which a pipe is cut by an abrasive cutting wheel rotating at a high speed, when cutting the pipe by gradually moving the rotating abrasive cutting wheel downward, the pipe is not precisely cut straight due to the resistance of the pipe (the workpiece). Further, chips produced by cutting can cause pollution of the pipe and start fires, thereby threatening the safety of a worker to thus result in inferior working circumstances.

In the sawing apparatus, while the adverse influence caused by chips can be decreased to some extent, when the pipe is cut by a saw cutter which is rotated above the pipe and is gradually moved downward, the pipe is not precisely cut straight due to the resistance of the workpiece. Also, post processing is required for subsequent beveling.

In the abrasive cutting apparatus and the sawing apparatus, in which cutting is conducted using a cutter (the abrasive cutting wheel or the saw cutter), in order to cut the workpiece, the cutter must have a diameter which is greater than that of the workpiece. In the case where the cutter has a diameter which is less than that of the workpiece, cutting is conducted in a manner such that a portion of the pipe is first cut and then the pipe is rotated to cut another portion of the pipe while maintaining the cutter at a fixed position. In this case, the safety of a worker is seriously threatened, and since the pipe is not cut straight, post processing is required. When the abrasive cutting apparatus or the sawing apparatus is used to cut a pipe having a large diameter, because the apparatus must have a size capable of accommodating the diameter of the pipe, they can be used only in a few large-sized factories, and cannot be used in most industrial construction sites.

A gas cutting apparatus has been widely used to cut a pipe having a large diameter. In the gas cutting apparatus, a mixture of combustible gas and air is ignited to obtain heat at a high temperature, and metal, that is, the material of the pipe, is melted and cut by high pressure flame. The gas cutting apparatus encounters problems in that rapid oxidization of the cut end of the pipe occurs , chips result in the pollution of the pipe, sparks produced while cutting the pipe and having high temperature are likely to start fires, and a plating material applied to the surface of the pipe for preventing corrosion of the pipe is burnt. Moreover, the gas cutting apparatus cannot be used to cut copper pipes, stainless pipes or aluminum pipes, because they have high thermal conductivity.

### DISCLOSURE OF INVENTION

### Technical Problem

Accordingly, the present invention has been made in an effort to solve the problems occurring in the related art, and an object of the present invention is to provide a method for cutting a pipe which allows circular pipes of all sizes to be cut using a single apparatus, permits precise straight cutting and beveling of a pipe, and can make work circumstances safe and clean, and an apparatus for performing the same.

### Technical Solution

In order to achieve the above object, according to one aspect of the present invention, there is provided a method for cutting a pipe, wherein, after a circular pipe to be cut is placed on a pair of rollers which are moved toward or away from each other, a portion of the circular pipe is cut by a cutter and the rollers are rotated so that the circular pipe can be cut by the cutter as it is rotated.

According to another aspect of the present invention, there is provided an apparatus for cutting a pipe, comprising a housing; guide bodies separately positioned on the housing to be selectively moved toward or away from each other; guide rolls installed on the guide bodies so that a pipe to be cut can be placed thereon; rotation means for manually or automatically rotating the guide rolls to rotate the pipe; and cutting means installed on a side surface of the housing, and having a cutting handle which is pivoted around a hinge to cut a lower portion of the pipe and a cutter which is installed on the distal end of the cutting handle.

According to another aspect of the present invention, the apparatus further comprises distance adjustment means having a distance adjustment handle which is provided on the front surface of the housing, and a distance adjustment shaft which extends from the distance adjustment handle and has two threaded portions which are formed in opposite directions and are threadedly coupled with the guide bodies.

According to another aspect of the present invention, the apparatus further comprises fastening means having a roller chain which has the other end secured to a rear surface of the housing and one end wound around the pipe and extending to the front surface of the housing, and a fastening handle which is provided on the front surface of the housing to pull the roller chain.

According to still another aspect of the present invention, the cutting means has a holding device for selectively interrupting the rotation of the cutting handle.

According to a still further aspect of the present invention, a reference roller is disposed between the guide bodies and the cutting means and is elastically supported to measure the height of the cutting surface of the pipe.

### BRIEF DESCRIPTION OF THE DRAWINGS

FIG. 1 is a drawing schematically illustrating a cutting apparatus in accordance with the present invention;

FIG. 2 is a view illustrating the distance adjustment means shown in FIG. 1;

FIG. 3 is a view illustrating the fastening means shown in FIG. 1;

FIG. 4 is a view illustrating the automatic rotation means for rotating guide rolls shown in FIG. 1;

FIG. 5 is a view illustrating the cutting means shown in FIG. 1;

FIGS. 6 through 9 are views explaining the operation of a reference roller;

FIG. 10 is a view illustrating the state in which a pipe is beveled by the cutting apparatus according to the present invention; and

FIG. 11 is a view illustrating the appearance of a circular pipe after being beveled.

### BEST MODE FOR CARRYING OUT THE INVENTION

Hereafter, a pipe cutting apparatus in accordance with a preferred embodiment of the present invention will be described with reference to the accompanying drawings.

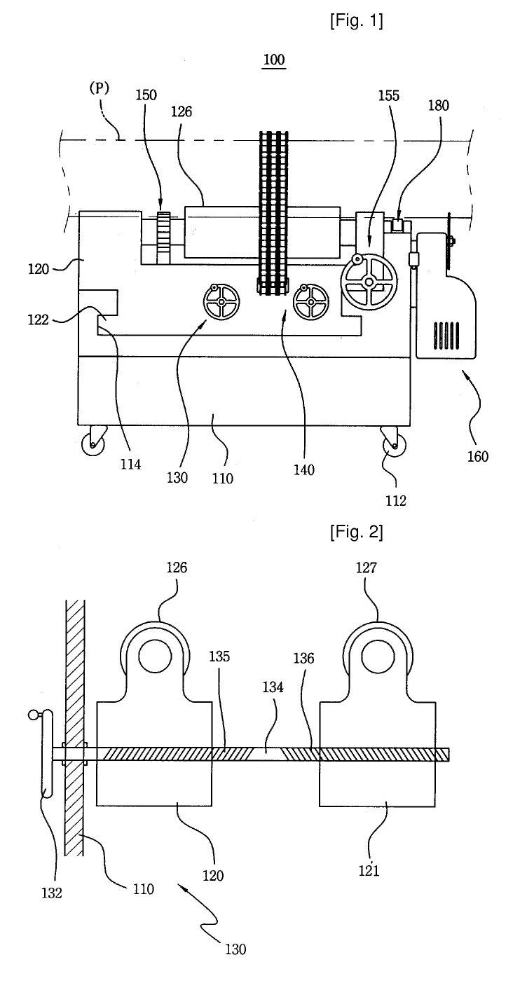

Referring to FIG. 1, a cutting apparatus 100 according to the present invention includes a housing 110, which has a plurality of wheels 112 on the lower surface thereof, a pair of guide rolls 126 and 127, which are formed on the upper surface of the housing 110 to support a circular pipe P, fastening means 140 for fastening the circular pipe P placed on the guide rolls 126 and 127, rotation means 150 and 155 for rotating the circular pipe P, and cutting means 160 for cutting the circular pipe P.

A pair of guide bodies 120 and 121 is arranged on the upper surface of the housing 110 to mount the guide rolls 126 and 127 thereon, such that the guide bodies 120 and 121 can be moved toward or away from each other.

In detail, guide grooves 114 are defined on the upper surface of the housing 110 in such a way as to be depressed inwards, and guide projections 122 to be engaged in the guide grooves 114 are formed on the pair of guide bodies 120 and 121. The guide rolls 126 and 127 are rotatably mounted to the upper ends of the guide bodies 120 and 121.

A distance adjustment handle 132 for operating the guide bodies 120 and 121 is provided on the front surface of the housing 110 and constitutes distance adjustment means 130 for allowing the guide bodies 120 and 121 to be moved toward or away from each other.

FIG. 2 illustrates the distance adjustment means 130. Referring to FIG. 2, an elongate distance adjustment shaft 134 is formed on the rear surface of the distance adjustment handle 132. The distance adjustment shaft 134 extends through the housing 110 and is threadedly coupled with the guide bodies 120 and 121. Two threaded portions 135 and 136 are formed on the distance adjustment shaft 134 in opposite directions to be threadedly coupled with the guide bodies 120 and 121, respectively. In other words, if a right-handed screw is formed on one portion of the distance adjustment shaft 134, a left-handed screw is formed on the other portion of the distance adjustment shaft 134. The portion of the distance adjustment shaft 134 that passes through the housing 110 has a structure for preventing the distance adjustment shaft 134 from being released from the housing 110. Therefore, by rotating the distance adjustment handle 132 clockwise or counterclockwise, the guide bodies 120 and 121 are moved toward or away from each other.

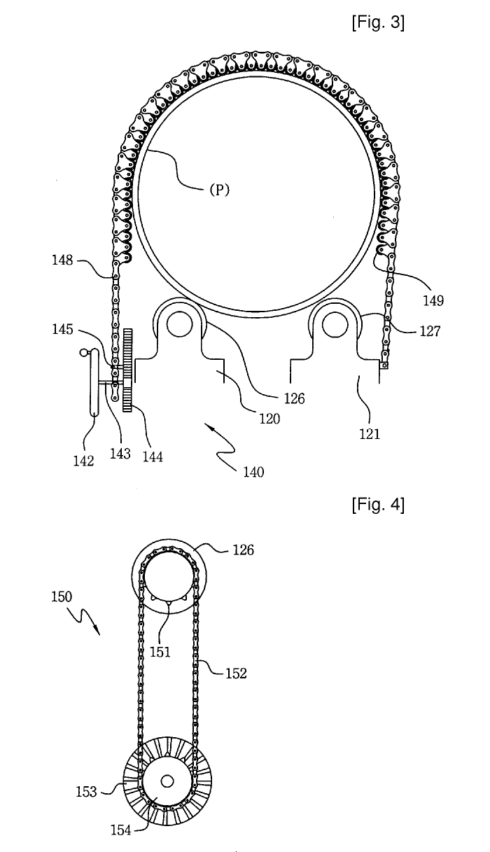

FIG. 3 is a view illustrating the fastening means 140 shown in FIG. 1. The fastening means 140 for fastening the circular pipe P placed on the pair of guide rolls 126 and 127 will be described below with reference to FIG. 3.

The fastening means 140 is composed of a fastening handle 142, which is provided on the front surface of the housing 110, and a roller chain 148 which is connected to the fastening handle 142 and is wound around the circular pipe P. The other end of the roller chain 148 is secured to the rear surface of the housing 110, and one end of the roller chain 148 is wound around the circular pipe P and extends to the front surface of the housing 110. Rollers 149 are provided on the entire intermediate portion of the roller chain 148, which excludes both end portions of the roller chain 148, such that, even though the circular pipe P is fastened with the roller chain 148 wound around the circular pipe P, the circular pipe P can be rotated without causing any problem thanks to the presence of the rollers 149 of the roller chain 148.

The fastening handle 142 functions to pull the roller chain 148 when manipulated. A fixed shaft 143 is formed on the rear surface of the fastening handle 142 and extends into the housing 110. A moving plate 144, which is disposed in a longitudinal direction, is gear-meshed with the fixed shaft 143. An engagement piece 145 is formed on the front surface of the moving plate 144 to project toward the front surface of the housing 110 and to be inserted into one end of the roller chain 148. Accordingly, if the fastening handle 142 is rotated clockwise or counterclockwise, the moving plate 144 is moved upward or downward through gear-meshing, and as a result, the roller chain 148, into which the engagement piece 145 is inserted, is loosened or tightened. Preferably, the fastening handle 142 performs only an actual function of pulling or releasing the roller chain 148.

Next, the rotation means 150 and 155 will be described.

The rotation means 150 and 155 function to rotate the guide rolls 126 and 127 with the circular pipe P fastened by the fastening means 140. The rotation means is composed of automatic rotation means 150 and manual rotation means 155. The automatic rotation means 150 will be first described.

In the automatic rotation means 150, as shown in FIG. 4, a sprocket 151 is formed on any guide roll 126, and a driving motor 153 and a driving sprocket 154, which are arranged in the housing 110, are connected to the sprocket 151 via a chain 152, such that the guide roll 126 can be automatically rotated through actuation of the driving motor 153.

In the manual rotation means 155, as shown in FIG. 1, a manual handle 156 is provided on the front surface of the housing 110, and the manual handle 156 and the guide roll 126 are connected with each other through connection means (not shown), such as a chain or gears, such that the guide roll 126 can be rotated using the manual handle 156. At this time, it is preferred that a device (not shown) for preventing the pipe from being rotated by a cutter 168 be installed.

The cutting means 160 will be described below with reference to FIG. 5.

Referring to FIG. 5, the cutting means 160 is provided to a side surface of the housing 110 to perform the function of cutting the circular pipe P. The cutting means 160 is composed of a cutting handle 162 which is coupled to the side surface of the housing 110 by a hinge 166 and has a front end projecting beyond the front surface of the housing 110, a cutter 168 which is secured to the rear end of the cutting handle 162, a driving motor (not shown) for rotating the cutter 168, and power transmission means (not shown) for connecting the driving motor and the cutter 168 with each other. A switch 164 for switching the rotation of the cutter 168 is provided on the front end portion 163 of the cutting handle 162. At this time, it is preferred that the cutter 168 be centrally positioned between the guide rolls 126 and 127 such that the center of the cutter 168 and the center of the circular pipe P, to be placed on the guide rolls 126 and 127, are aligned with each other in a vertical direction. It is preferred that the cutting handle 162, excluding the front end portion 163 thereof, which is exposed to the outside, the driving motor, and the power transmission means be received in a case 169. The power transmission means may comprise a chain, gears, or a belt.

A holding device (not shown) can be provided between the hinge 166 and the front end portion 163 of the cutting handle 162 to allow the cutting handle 162 to be smoothly manipulated and to selectively interrupt the rotation of the cutting handle 162.

It is preferred that the cutting means 160 be provided with a device for controlling the rotational speed of the cutter 168.

Further, a number of safety devices are needed. Namely, since the cutter 168 rotates at a high speed, a control section may be disposed between a power supply section and the driving motor to control the rotation of the cutter 168 in conformity with the current situation. For example, if an excessive load is applied to the cutter 168, even though the switch 164 remains turned on, the rotation of the cutter 168 can be automatically stopped. Also, it is conceivable that the cutter 168 can be prevented from rotating upon the application of current while the switch 164 is turned on.

The cutting apparatus 100 according to the present invention has a reference roller 180 which is arranged between the guide bodies 120 and 121 and the cutting means 160 as auxiliary means for cutting the circular pipe P, irrespective of the size of a circular pipe P.

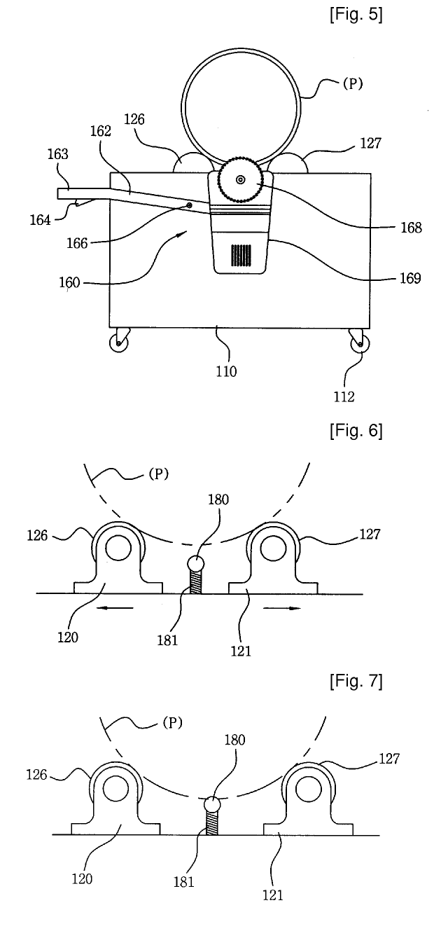

Referring to FIGS. 1 and 6, the reference roller 180 is positioned at the true center between the pair of guide rolls 126 and 127. The reference roller 180 functions to set the seating height of the circular pipe P to be placed on the guide rolls 126 and 127 or the cutting height of the cutter 168. The reference roller 180 serves as a device for establishing a reference point for the movement of the cutting means 160, and is elastically supported by a high-elasticity spring 181.

Describing the function of the reference roller 180 in further detail, the reference roller 180 is associated with the top dead point and the bottom dead point of the cutter 168, which is reciprocated in the vertical direction. That is to say, the normal height of the reference roller 180 is set to be slightly lower than the top dead point of the cutter 168, and the maximum lowered height of the reference roller 180 is set to be slightly higher than the bottom dead point of the cutter 168.

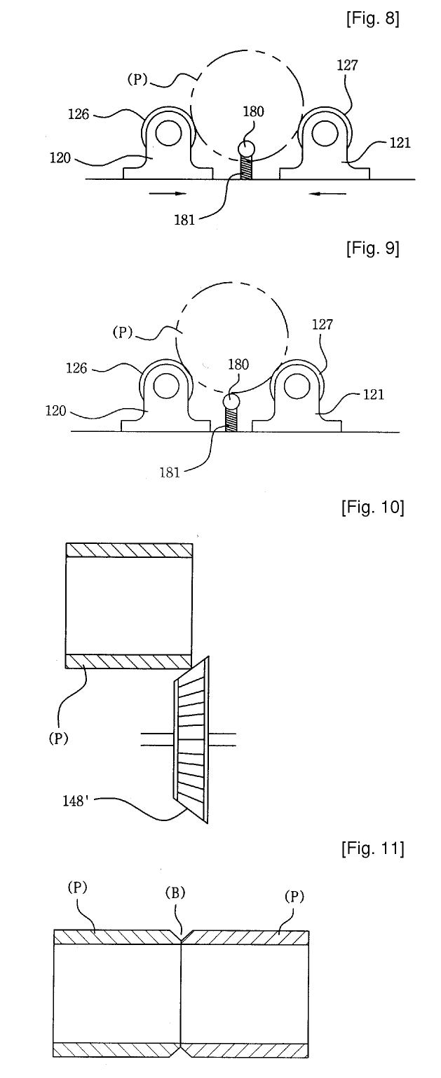

When the circular pipe P is placed on the guide rolls 126 and 127, since the height of the lower portion of the circular pipe P, that is, a portion of the circular pipe P that is cut, changes depending upon the diameter of the circular pipe P, it is necessary to move the guide bodies 120 and 121 such that the height of the portion of the circular pipe P to be cut is set to correspond to the cutting height of the cutter 168. At this time, if a circular pipe P having a large diameter is placed on the guide rollers 126 and 127 as shown in FIG. 6, the portion of the circular pipe P to be cut is positioned higher than the upper end of the reference roller 180. In this case, the guide bodies 120 and 121 are moved away from each other by the distance adjustment means 130 so that the circular pipe P can be lowered and the portion of the circular pipe P to be cut is brought into contact with the reference roller 180 in a reference position, as shown in FIG. 7. On the contrary, if a circular pipe P having a small diameter is placed on the guide rollers 126 and 127, as shown in FIG. 8, the portion of the circular pipe P to be cut presses the reference roller 180 so that the reference roller 180 is moved so that it is lower than the bottom dead point. In this case, the guide bodies 120 and 121 are moved toward each other by the distance adjustment means 130 so that the circular pipe P can be raised and the portion of the circular pipe P to be cut is brought into contact with the reference roller 180 in the reference position, as shown in FIG. 9.

Meanwhile, the cutting apparatus 100 according to the present invention can perform not only a simple cutting function but also a beveling function.

Referring to FIG. 10, in the cutting apparatus 100 according to the present invention, after cutting is finished, to enable the beveling of a cut surface, the cutter 168 is removed and a beveling blade 168′ is mounted to the cutting means 160. Then, after bringing the edge of the cut surface of the circular pipe P into contact with the beveling blade 168′, by operating the cutting means 160 and the automatic or manual rotation means 150 or 155, beveling of the circular pipe P is conducted.

The beveled circular pipes P are abutted with each other on the beveled portions B thereof, and are connected with each other through welding.

### INDUSTRIAL APPLICABILITY

As is apparent from the above description, in the cutting apparatus according to the present invention, after a circular pipe is placed on a pair of guide rolls and is fastened by a roller chain, the lower portion of the pipe is cut by cutting means and then the guide rolls are rotated to allow the cutting operation to be continuously performed, so that the cut portion of the pipe has a precisely straight cut surface and beveling can be immediately conducted.

The cutting apparatus according to the present invention can be used both manually and automatically, can be used irrespective of the size of a pipe, and is better suited to relatively large pipes than the conventional cutting apparatus.

Furthermore, there is no limitation on the material of the pipe, chips can be completely removed, thus reducing pollution of the pipe, and the possibility of fires and environmental pollution is eliminated.

In the drawings and specification, typical preferred embodiments of the invention have been disclosed, and, although specific terms are employed, they are used in a generic and descriptive sense only and not for purposes of limitation, the scope of the invention being set forth in the following claims.

1. A method for cutting a pipe, wherein, after a circular pipe to be cut is placed on a pair of rollers which are moved toward or away from each other, a portion of the circular pipe is cut by a cutter and the rollers are rotated so that the circular pipe can be cut by the cutter as it is rotated.

2. An apparatus for cutting a pipe, comprising: a housing; guide bodies separately positioned on the housing to be selectively moved toward or away from each other; guide rolls installed on the guide bodies so that a pipe to be cut can be placed thereon; rotation means for manually or automatically rotating the guide rolls to rotate the pipe; and cutting means installed on a side surface of the housing, and having a cutting handle which is pivoted around a hinge to cut a lower portion of the pipe and a cutter which is installed on a distal end of the cutting handle.

3. The apparatus according to claim 2, further comprising: distance adjustment means having a distance adjustment handle which is provided on a front surface of the housing, and a distance adjustment shaft which extends from the distance adjustment handle and has two threaded portions formed in opposite directions and threadedly coupled with the guide bodies.

4. The apparatus according to claim 2, further comprising: fastening means having a roller chain which has another end secured to a rear surface of the housing and one end wound around the pipe and extending to the front surface of the housing, and a fastening handle which is provided on the front surface of the housing to pull the roller chain.

5. The apparatus according to claim 4, wherein a fixed shaft is formed on a rear surface of the fastening handle to extend into the housing, a longitudinal moving plate is gear-meshed with the fixed shaft, and an engagement piece is formed on a front surface of the longitudinal moving plate to project toward the front surface of the housing and to be inserted into the roller chain.

6. The apparatus according to claim 2, wherein the cutting means has a holding device for selectively interrupting rotation of the cutting handle.

7. The apparatus according to claim 2, wherein a reference roller is disposed between the guide bodies and the cutting means and is elastically supported to measure a height of a cutting surface of the pipe.
